(19) United States
(12) Patent Application Publication
(10) Pub. No.: US 2017/0009063 A1
(43) Pub. Date: Jan. 12, 2017

(54) THERMOPLASTIC MOULDING MATERIALS

(71) Applicant: LANXESS Deutschland GmbH, Cologne (DE)

(72) Inventors: Thomas LINDER, Cologne (DE); Detlev JOACHIMI, Krefeld (DE)

(21) Appl. No.: 15/203,891

(22) Filed: Jul. 7, 2016

(30) Foreign Application Priority Data
Jul. 10, 2015 (EP) 15176240.8

(51) Int. Cl. C08K 13/04

(52) U.S. Cl. CPC C08K 13/04

(57) ABSTRACT

Polyamide-based compositions may be heat stabilized by compositions of iron oxalate and diapentaerythritol. The heat stabilized polyamides may be used for production of moulding materials which may be injection moulded, blow-moulded, or extruded to provide articles of manufacture.

The present invention relates to heat-stabilized polyamide-based compositions based on iron oxalate and diapentaerythritol, to moulding materials producible therefrom and in turn to injection moulded, blowmoulded or extruded articles of manufacture producible therefrom.

### BACKGROUND INFORMATION

Polyamides, in particular partly crystalline polyamides, are often used as materials of construction for mouldings which are exposed to elevated temperatures over a prolonged period during their lifetime. It is necessary for a great many applications that the materials of construction be sufficiently stable toward the attendant thermooxidative damage, in particular for engine bay applications in motor vehicles.

Glass fibre-reinforced polyamide 66 compounds have become established in automobile construction for the production of articles of manufacture subject to high levels of thermal stress, wherein high levels of thermal stress is to be understood as meaning a temperature of 180° C. to 240° C., temperatures which may nowadays readily occur in the engine bay of motor vehicles with combustion engines, in particular when the articles of manufacture are turbo charge air pipes, intake pipes, cylinder head covers, charge air coolers or engine covers.

On account of the increases in motor vehicle engine performance realized in recent years, manufacturers impose ever higher requirements on the materials used for producing these articles of manufacture. Polyamides generally exhibit a deterioration in their mechanical properties when they are subjected to elevated temperatures over a prolonged period. This effect is based primarily on oxidative damage to the polyamide at elevated temperatures (thermooxidative damage). A prolonged period in the context of the present invention means longer than 100 hours; elevated temperatures in the context of the present invention means higher than 80° C.

The stability of thermoplastic moulding materials/articles of manufacture produced therefrom to thermooxidative damage is typically assessed by comparison of mechanical properties, in particular of impact resistance, of breaking stress and breaking elongation measured in the tensile test as per ISO 527, and of elastic modulus at defined temperature, over a defined period.

The thermooxidative degradation of polyamide-based articles of manufacture at elevated temperatures over a prolonged period generally cannot be prevented, only delayed, with stabilizer systems. The requirements imposed on thernnoplastic polyamide-based moulding materials/articles of manufacture producible therefrom in high-temperature applications are not yet sufficiently met by prior art systems. Thus, for example, such articles of manufacture experience a marked drop in impact resistance or breaking stress, usually to less than 50% of the initial value, after 1000 hours of long-term storage at temperatures of 180° C. to 200° C.

WO 2013/139743 A1 already describes, inter alia, iron oxalate-comprising polyamide-based moulding materials and articles of manufacture producible therefrom having good thermal stability. However, the thermal stability of articles of manufacture produced according to WO 2013/139743 A1 did not always prove satisfactory.

The problem addressed by the present invention was therefore to further improve the stabilization of polyamides, and articles of manufacture fabricatable therefrom, towards thermooxidative damage and in terms of photooxidative damage.

### SUMMARY OF THE INVENTION

The solution to the problem and subject-matter of the present invention are compositions comprising

A) at least one polyamide or copolyamide,
B) iron oxalate, preferably with an average particle diameter below 10 μm, determined by light scattering as per ISO 13320 following dispersion in water as per ISO 14887,
C) dipentaerythritol, and
D) at least one filler or reinforcer.

It is noted for the avoidance of doubt that the scope of the invention encompasses all below-referenced definitions and parameters referred to in general terms or within preferred ranges in any desired combinations, wherein any ranges specified include ranges that span from specified endpoint to specified endpoint, as well as intermediary ranges which span from any value between specified endpoints to either of: any other value between specified endpoints or to either specified endpoint.

The preparation of inventive compositions for the production of moulding materials for further use in injection moulding, in extrusion or for blow moulding is effected by mixing the individual components A), B), C) and D) in at least one mixing assembly, preferably a compounder, particularly preferably a corotating twin-screw extruder. This gives, as intermediates, moulding materials. These moulding materials—also known as thermoplastic moulding materials—may either be composed exclusively of the components A), B), C), and D) or else may contain, in addition to the components A), B), C) and D), further components.

The present invention preferably provides compositions and moulding materials and articles of manufacture producible therefrom employing, per 100 parts by weight of component A), about 0.05 to about 6 parts by weight of component B), about 0.1 to about 12 parts by weight of component C), and about 5 to about 280 parts by weight of component D).

### DESCRIPTION

In the case of the moulding materials, and articles of manufacture producible therefrom, the proportion of the inventive compositions therein may be about 40 to 100 wt %, the remaining constituents being added substances selected by those skilled in the art in accordance with the later use of the articles of manufacture, preferably from at least one of the components E) to G) defined hereinbelow. When the moulding materials comprise, in addition to the components A), B), C) and D), further components, in particular at least one of the components E), F) and/or G) listed hereinbelow, the proportion of at least one of the components A), B), C) and D) is reduced by an extent such that the sum of all weight percentages in the moulding material is always 100.

In a preferred embodiment the compositions and also the moulding materials and articles of manufacture producible therefrom further comprise at least one further heat stabilizer E). It is preferable to employ about 0.03 to about 2 parts by weight of component E) per 100 parts by weight of component A). It is preferable to employ at least one heat stabilizer from the group of copper halides as component E).

In a preferred embodiment the compositions and the moulding materials and articles of manufacture producible therefrom further comprise, in addition to the components A) to E), at least one alkali metal halide F). It is preferable to employ about 0.01 to about 2 parts by weight of component F) per 100 parts by weight of the component A).

In a preferred embodiment the compositions and the moulding materials and articles of manufacture producible therefrom further comprise, in addition to the components A) to F) or instead of the components E) and/or F), at least one further additive G). It is preferable to employ about 0.05 to about 20 parts by weight of the component G) per 100 parts by weight of the component A).

### Component A)

The polyamides for use as component A) are preferably amorphous polyamides or partly crystalline polyamides. The inventive stabilizer system composed of the components B) and C) is particularly preferably employed for polyamides used in high temperature applications, very particularly preferably for partly crystalline polyamides having a melting point of at least about 180° C. or amorphous polyamides having a glass transition temperature of at least about 150° C.

The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is indicated, as in the case of PA 6, this means that the starting material was an α,ω-aminocarboxylic acid or the lactam derived therefrom, i.e. ε-caprolactam in the case of PA 6; for further information, reference is made to H. Domininghaus, Die Kunststoffe und ihre Eigenschaften [Polymers and Their Properties], pages 272 ff., VDI-Verlag, 1976.

It is preferable when at least one partly crystalline polyamide, particularly preferably at least polyamide 6 (PA6) [CAS No. 25038-54-4] or polyamide 66 (PA66) [CAS No. 32131-17-2], in particular polyamide 66, is used as component A).

The PA 6 and PA 66 preferred for use as component A) are partly crystalline polyamides. According to DE 10 2011 084 519 A1 partly crystalline polyamides have an enthalpy of fusion of about 4 to about 25 J/g measured by the DSC method to ISO 11357 in the 2nd heating and Integration of the melt peak. By contrast, amorphous polyamides have an enthalpy of fusion of less than 4 J/g measured by the DSC method to ISO 11357 in the 2nd heating and integration of the melt peak.

In one embodiment a blend of different polyamides is also used as component A).

It is especially particularly preferable when polyamide 6 or polyamide 66 having relative solution viscosities of about 2.0 to about 4.0 in m-cresol are used as component A). It is especially very particularly preferable when polyamide 66 having a relative solution viscosity of about 2.6-3.2 in m-cresol is used.

Methods of determining relative solution viscosity comprise measuring the flow times for a dissolved polymer through an Ubbelohde viscometer in order then to determine the viscosity difference between the polymer solution and its solvent, in this case m-cresol (1% solution). Applicable standards are DIN 51562, DIN ISO 1628 or corresponding standards.

The polyamides for use as component A) may be produced by various methods and synthesized from different monomers. Polyamides are obtainable via a multiplicity of existing procedures involving the use, depending on the desired end product, of different monomeric building blocks, various chain transfer agents to achieve a target molecular weight, or else monomers having reactive groups for subsequently intended aftertreatments.

Industrially relevant methods of producing polyamides preferably employed according to the invention usually proceed via polycondensation in the melt. In the context of the present invention polycondensation also comprehends the hydrolytic polymerization of lactams.

Polyamides preferred in accordance with the invention are partly crystalline polyamides which can be produced from diamines and dicarboxylic acids and/or lactams having at least 5 ring members or corresponding amino acids. Contemplated reactants are preferably aliphatic and/or aromatic dicarboxylic acids, particularly preferably adipic acid, 2,2,4-trimethyladipic acid, 2,4,4-trimethyladipic acid, azelaic acid, sebacic acid, isophthalic acid, terephthalic acid, aliphatic and/or aromatic diamines, particularly preferably tetramethylenediamine, hexamethylenediamine, 2-methylpentane-1,5-diamine, nonane-1,9-diamine, 2,2,4- and 2,4,4-triexamyhexethylenediamine, the isomeric diaminoyclohexylmethanes, diaminodicyclohexylpropane, bis(aminomethyl)cyclohexane, phenylenediamine, xylylenediamine, aminocarboxylic acids, in particular aminocaproic acid, or the corresponding lactams. Copolyamides of a plurality of the monomers mentioned are included.

Homopolyamides of the AS type preferred in accordance with the invention are obtained either through polycondensation (straight-chain monomer, example: ε-aminocaproic acid) or ring-opening polymerization (cyclic monomer, example: ε-caprolactam). Homopolyamides of the AS type particularly preferred in accordance with the invention are produced from caprolactam, very particularly preferably from ε-caprolactam. By contrast, polymers of the AA-SS type preferred in accordance with the invention are produced by polycondensation of a diamine and dicarboxylic acid. PA66 which is particularly preferred in accordance with the invention is produced from hexamethylenediamine and adipic acid.

Especial particular preference is moreover given to most compounds based on PA6, PA66 and other compounds based on aliphatic or/and aromatic polyamides/copolyamides, where there are about 3 to about 11 methylene groups in the polymer chain per polyamide group.

### Component B)

As component B), iron oxalate [CAS No. 516-03-0] is used. It is preferable when iron(II) oxalate dihydrate [CAS No. 6047-25-2] or iron(II) oxalate hexahydrate [CAS No. 166897-40-1], in particular iron(III) oxalate dihydrate, is used as component B). The latter is also referred to in simplified terms as iron oxalate dihydrate.

The iron oxalate for use as component B) preferably has an average particle diameter, i.e. a d₅₀, below 10 μm, not including the value zero. The iron oxalate for use in accordance with the invention particularly preferably has a d₅₀ of about 1 to about 8 μm, very particularly preferably about 1.5 to about 5 μm, and especially preferably about 2 to about 2.5 μm. According to the invention the do is determined by light scattering as per ISO 13320 after dispersion in water as per ISO 14887. Alternative dispersants are described in table 2 of the white paper “Dispersing Powders in Liquid for Particle Size Analysis” from Horiba Instruments Inc, Albany, N.Y., 2013. Preferred alternatives according to said table would be acetone or ethylene glycol.

The iron oxalate for use as component B) moreover preferably has a d₅₀ value below about 20 μm—not including the value zero-, particularly preferably about 2 to about 12 μm, and very particularly preferably about 5 to about 10 μm.

The average particle diameters are achieved by grinding iron oxalate. In terms of the d₅₀, d₉₀ and d₉₉ values in this application, the determination thereof and the meaning thereof, reference is made to Chemie Ingenieur Technik (72) pp. 273-276, 3/2000, Wiley-VCH Verlags GmbH, Weinheim, 2000, according to which the d₅₀ value is that particle size below which 50% of the amount of particles lie (median value) and the d₅₀ value is that particle size below which 90% of the amount of particles lie. For the sake of clarity it is noted that a material having a d₉₉<10 μm naturally also has a d₅₀<10 μm.

### Component C)

As component C), Dipentaerythritol [CAS No. 126-58-9] is used. Dipentaerythritol is available from Perstorp for example (Dipenta 93).

### Component D)

As component D), fibrous, acicular or particulate fillers and reinforcers are preferably used.

Preference is given to carbon fibres, glass beads, ground glass, amorphous silica, calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8] or glass fibres [CAS No. 65997-17-3]. Particular preference is given to using glass fibres, especially preferably glass fibres of E-glass. In a preferred embodiment the fibrous or particulate fillers and reinforcers are provided with suitable surface modifications, especially surface modifications comprising silane chemistries, for better compatibility with the component A). Especially preferably used as component D) are glass fibres having a circular cross section and a filament diameter of about 6 to about 11 μm or flat glass fibres of noncircular cross section whose principle cross-sectional axis has a width of about 6 to about 40 μm and whose secondary cross-sectional axis has a width of about 3 to about 20 μm, where data reported in the glass fibre manufacturer technical datasheets are to be used to determine whether a glass fibre product belongs to this dimension range. For example, glass fibre CS7928 from Lanxess Deutschland GmbH (circular cross section, average diameter about 11 μm) may be used with especial preference. In the context of the present invention cross-sectional area/filament diameter are determined by means of at least one optical method analogously to DIN 65571. Optical methods are a) optical microscope and ocular micrometer (distance measurement cylinder diameter), b) optical microscope and digital camera with subsequent planimetry (cross section measurement), c) laser interferometry and d) projection.

### Component E)

As component E), at least one heat stabilizer additional to component B) and selected from the group of copper halides is used. Preferably at least one copper(I) halide is used, particularly preferably at least copper(I) iodide [CAS No. 7681-65-4].

### Component F)

As component F), at least one alkali metal halide is used. Preferred alkali metal halides are alkali metal chlorides, alkali metal bromides or alkali metal iodides, particularly preferably alkali metal halides of the metals sodium or potassium, very particularly preferably sodium chloride, potassium bromide or potassium iodide, especially preferably potassium iodide [CAS No. 7681-11-0] or potassium bromide [CAS No. 7758-02-3], especially very particularly preferably potassium bromide.

It is preferable when at least one representative of the component E) is used together with one representative of the component F). It is preferable in accordance with the invention when copper(I) iodide is used with potassium bromide. In alternative embodiments it is preferable to use copper(I) iodide with potassium iodide.

### Component G)

As a further additive of the component G) it is preferable to use at least one substance from the group of heat stabilizers distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes and pigments. These and further suitable additives are prior art and can be found by the person skilled in the art, for example, in the Plastics Additives Handbook, 5th Edition, Hanser-Verlag, Munich, 2001, pages 80-84, 546-547, 688, 872-874, 938, 966. The additives for use as component (G) may be used alone or in admixture/in the form of masterbatches.

Additional heat stabilizers for use as additives in accordance with the invention and distinct from the components B) and E) are preferably metal halides or alkaline earth metal halides distinct from component F), preferably calcium chloride or manganese chloride, sterically hindered phenols and/or phosphites, phosphates, preferably disodium dihydrogendiphosphate, hydroquinones, aromatic secondary amines, in particular diphenylamines, substituted resorcinols, salicylates, benzotriazoles or benzophenones, and variously substituted representatives of these groups and/or mixtures thereof.

UV-Stabilizers for use as an additive in accordance with the invention are preferably substituted resorcinois, salicylates, benzotriazoles or benzophenones.

The impact modifiers or elastomer modifiers for use as an additive are preferably copolymers preferably constructed from at least two of the following series of monomers: ethylene, propylene, butadiene, isobutene, isoprene, chloroprene, vinyl acetate, styrene, acrylonitrile and acrylic ester or methacrylic ester having 1 to 18 carbon atoms in the alcohol component. The copolymers may contain compatibilizing groups, preferably maleic anhydride or epoxide. Copolymers of ethylene and acrylic ester are preferably used. Copolymers of ethylene and 2-ethylhexyl acrylate are particularly preferably used.

Dyes or pigments, zinc sulfide for use as an additive in accordance with the invention are preferably inorganic pigments, particularly preferably titanium dioxide, ultramarine blue, iron oxide, zinc sulfide or carbon black, and also organic pigments, particularly preferably phthalocyanines, quinacridones, perylenes, and dyes, particularly preferably nigrosine or anthraquinones as colourants and also other colourants.

Nucleating agents for use as an additive in accordance with the invention are preferably sodium or calcium phenylphosphinate, aluminium oxide, silicon dioxide or talc. Particular preference is given to using talc [CAS No. 14807-96-6] as a nucleating agent, in particular microcrystalline talc. Talc is a sheet silicate having the chemical composition Mg₃[Si₄O₁₀(OH)₂], which, depending on the modification, crystallizes as talc-1A in the triclinic crystal system or as talc-2M in the monoclinic crystal system (http://de.wikipedia.org/wiki/Talkum). Talc for use in accordance with the invention is commercially available, for example, under the name Mistron® R10 from Imerys Talc Group, Toulouse, France (Rio Tinto Group).

Lubricating and/or demoulding agents for use as an additive in accordance with the invention are preferably long-chain fatty acids, in particular stearic acid, salts thereof, in particular calcium or zinc stearate, and the ester derivatives or amide derivatives thereof, in particular ethylenebisstearylamide, glyceryl tristearate, stearyl stearate, montan ester waxes, in particular esters of montan acids with ethylene glycol, and low molecular weight polyethylene/polypropylene waxes in oxidized and nonoxidized form. Lubricating and/or demoulding agents particularly preferred in accordance with the invention belong to the group of esters or amides of saturated or unsaturated aliphatic carboxylic acids having about 8 to about 40 carbon atoms with saturated aliphatic alcohols or amines having about 2 to about 40 carbon atoms. In a further preferred embodiment, the inventive compositions/moulding materials comprise mixtures of the abovementioned lubricating and/or demoulding agents. Montan ester waxes, also known as montan waxes [CAS No. 8002-53-7] for short, preferred for use as demoulding agents are mixtures of straight-chain, saturated carboxylic acids having chain lengths of 28 to 32 carbon atoms. Such montan ester waxes are commercially available from Clariant International Ltd. under the name Licowax®. Used with particular preference in accordance with the invention are Licowax® E, or a mixture of waxes, preferably mixtures of ester waxes, amide waxes and/or saponified waxes according to EP 2607419 A1, the content of which is hereby fully incorporated by reference into the present invention.

The present invention preferably relates to compositions comprising A) PA 66, B) iron oxalate dihydrate, C) dipentaerythritol and D) glass fibres and also to moulding materials and articles of manufacture producible therefrom.

The present invention preferably also relates to compositions comprising A) PA 66, B) iron oxalate dihydrate, C) dipentaerythritol, D) glass fibres, E) copper(I) iodide and potassium iodide, and also to moulding materials and articles of manufacture producible therefrom.

The present invention preferably also relates to compositions comprising A) PA 66, B) iron oxalate dihydrate. C) dipentaerythritol, D) glass fibres, E) copper(I) iodide and F) potassium bromide and also to moulding materials and articles of manufacture producible therefrom.

The present invention preferably also relates to compositions comprising A) PA 66, B) iron oxalate dihydrate, C) dipentaerythritol, D) glass fibres, E) copper(I) iodide, F) potassium bromide and G) montan ester wax, and also to moulding materials and articles of manufacture producible therefrom.

The present invention preferably also relates to compositions comprising A) PA 66, B) iron oxalate dihydrate, C) dipentaerythritol, D) glass fibres, E) copper(I) iodide, F) potassium iodide and G) montan ester wax, and also to moulding materials and articles of manufacture producible therefrom.

The present invention preferably relates to compositions comprising A) polyamide or copolyamide, B) iron oxalate, C) dipentaerythritol, D) glass fibres and G) at least one copolymer of ethylene and acrylic ester.

The present invention preferably relates to compositions comprising A) polyamide or copolyamide, B) iron oxalate, C) dipentaerythritol, D) glass fibres and G) at least one copolymer of ethylene and 2-ethylhexyl acrylate.

The present invention preferably relates to compositions comprising A) polyamide 66, B) iron oxalate, C) dipentaerythritol, D) glass fibres and G) at least one copolymer of ethylene and acrylic ester.

The present invention preferably relates to compositions comprising A) polyamide 66, B) iron oxalate, C) dipentaerythritol, D) glass fibres and G) at least one copolymer of ethylene and 2-ethylhexyl acrylate.

The present invention preferably relates to compositions comprising A) polyamide or copolyamide, B) iron oxalate dihydrate, C) dipentaerythritol, D) glass fibres and G) at least one copolymer of ethylene and acrylic ester.

The present invention preferably relates to compositions comprising A) polyamide or copolyamide, B) iron oxalate dihydrate, C) dipentaerythritol, D) glass fibres and G) at least one copolymer of ethylene and 2-ethylhexyl acrylate.

The present invention preferably relates to compositions comprising A) polyamide 66, B) Iron oxalate dihydrate, C) dipentaerythritol, D) glass fibres and G) at least one copolymer of ethylene and acrylic ester.

The present invention preferably relates to compositions comprising A) polyamide 66, B) Iron oxalate dihydrate, C) dipentaerythritol, D) glass fibres and G) at least one copolymer of ethylene and 2-ethylhexyl acrylate.

### Method

The present invention also provides a method of producing inventive thermoplastic moulding materials and articles of manufacture producible therefrom by mixing the components A) to D) and optionally at least one representative of the components E), F) and G) in appropriate weight fractions. The mixing of the components is preferably accomplished at temperatures of about 220° C. to about 400° C. by conjoint mingling, blending, kneading, extruding or rolling. Preferred mixing assemblies are selected from compounders, corotating twin-screw extruders and Buss kneaders. It may be advantageous to premix individual components. The term ‘compound’ refers to mixtures of raw materials which have had additional fillers, reinforcers or other additives admixed with them. This does not result in dissolution of the individual raw materials in one another. Thus compounding combines at least two substances with one another to afford a homogeneous mixture. Compounding is intended to modify the properties of the raw materials to suit an application. A particular challenge is to avoid possible demixing of the compound over time. The procedure for producing a compound is referred to as compounding.

In a preferred embodiment the moulding materials according to the invention are produced in a two-stage process. In the first step the component B) is blended with component A) to afford a premixture. Other components may also be blended with the component B) and the component A) in this first step. This first step is preferably carried out in a corotating twin-screw extruder, Buss kneader or planetary-gear extruder. These mixers preferably have a degassing function to discharge the gaseous components formed during reaction of the component B).

In a preferred embodiment the premixture in the first step additionally comprises at least one processing stabilizer as well as the two components A) and B). Preferably employed processing stabilizers are sterically hindered phenols and/or phosphites, phosphates, hydroquinones, aromatic secondary amines, in particular diphenylamines, substituted resorcinols, salicylates, benzotriazoles or benzophenones, and also variously substituted representatives of these groups and/or mixtures thereof.

The proportion of component B) in the premixture obtainable from the first step is preferably about 1 to about 60 wt %, particularly preferably about 1 to about 30 wt %, and very particularly preferably about 2 to about 20 wt %.

The component B) may alternatively be reacted in a suitable substance of component G) in a twin-screw extruder, Buss kneader or another mixing assembly suitable for heating the mixture to temperatures above the reaction temperature of the component B). It is also possible to employ a batchwise method, preferably in a stirred autoclave, in the first step.

In an alternative preferred embodiment the component B) is used in combination with one or more chemistries which increase the reaction rate of the component B). This makes reaction of component B) at lower temperatures possible. Such chemistries also known as activators are described, for example, in U.S. Pat. No. 4,438,223, the content of which is hereby fully incorporated by reference. In this case it is preferable to employ as an activator at least one chemistry from the series of sodium or potassium hydrogencarbonate, sodium or potassium acetate, sodium or potassium carbonate, sodium or potassium chloride, sodium or potassium bromide, sodium or potassium iodide, sodium or potassium rhodanine or sodium or potassium benzoate.

In the second step the premixture from the first step is blended with the remaining components according to the above described methods.

After mixing, compositions in the form of moulding materials are then preferably extruded, cooled until pelletizable and pelletized. In one embodiment, the pelletized material comprising the inventive composition is dried, preferably at temperatures of 110° C. to 130° C., particularly preferably around 120° C., in a vacuum drying cabinet or in a dry air drier, preferably for a duration of up to about 2 h, before being subjected as matrix material to an Injection moulding operation, a blow moulding operation or an extrusion process to produce inventive articles of manufacture.

The present invention thus also relates to a method of producing articles of manufacture wherein inventive compositions are blended, extruded to form a moulding material, cooled until pelletizable and pelletized and subjected as matrix material to an injection moulding, blow moulding or extrusion operation, preferably an injection moulding operation.

It may be advantageous to directly produce so-called semifinished products from a physical mixture produced at room temperature, preferably at a temperature of about 0° C. to about 40° C., a so-called dryblend, of premixed components and/or individual components. In the context of the present invention semifinished products are prefabricated items and are formed in a first step in the production process of an article of manufacture. In the context of the present invention ‘semifinished products’ does not comprehend bulk goods, pelletized materials or powders because, unlike semifinished products, these are not geometrically defined solid objects and as such no “semifinishing” of the final article of manufacture has been effected. See: http://de.wikipedia.org/wiki/Halbzeug.

The processes of injection moulding, of blow moulding and of extrusion of thermoplastic moulding materials are known to those skilled in the art.

Methods according to the invention for producing polyamide-based articles of manufacture by extrusion or injection moulding are carried out at melt temperatures of about 240° C. to about 330° C., preferably about 260° C. to about 310° C., particularly preferably about 270° C. to about 300° C., and optionally also at pressures of not more than about 2500 bar, preferably at pressures of not more than about 2000 bar, particularly preferably at pressures of not more than about 1500 bar, and very particularly preferably at pressures of not more than about 750 bar.

Sequential coextrusion involves expelling two different materials successively in alternating sequence. In this way, a preform having a different material composition section by section in the extrusion direction is formed. Particular article sections may be endowed with specifically required properties by appropriate material selection, for example for articles having soft ends and a hard middle part or integrated soft gaiter regions (Thielen, Hartwig, Gust, “Blasformen von Kunststoffhohlkörpern”, Carl Hanser Verlag, Munich 2006, pages 127-129).

In the process of injection moulding a moulding material comprising the inventive compositions, preferably in pellet form, is melted in a heated cylindrical cavity (i.e. plasticated) and injected under pressure into a heated cavity as an injection moulding material. After cooling (solidification) of the material, the injection moulding is demoulded.

The following operations are distinguished:

1. plastication/melting
2. injection phase (filling operation)
3. hold pressure phase (because of thermal contraction during crystallization)
4. demoulding.

In this regard, see http://de.wikipedia.org/wiki/Spritzgie%C3%9Fen. An injection moulding machine comprises a closure unit, the injection unit, the drive and the control system. The closure unit includes fixed and movable platens for the mould, an end platen, and tie bars and the drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pelletized material. The problem of melt backflow inside the screw (leakage flow) is solved by nonreturn valves.

In the injection mould, the incoming melt is then separated and cooled and the article of manufacture to be fabricated is thus fabricated. Two halves of the mould are always required therefor. In injection moulding, the following functional systems are distinguished:
runner system
shaping inserts
venting
machine mounting and force absorption
demoulding system and motion transmission
heating

In contrast to injection moulding, in extrusion an endless plastics extrudate of an inventive moulding material is employed in an extruder, the extruder being a machine for producing shaped thermoplastic mouldings. Reference is made here to http://de.wikipedia.org/wiki/Extrusionsblasformen. A distinction is made between single-screw extruders and twin-screw extruders, and also between the respective subgroups of conventional single-screw extruders, conveying single-screw extruders, contrarotating twin-screw extruders and corotating twin-screw extruders.

Extrusion plants comprise the elements extruder, mould, downstream equipment, extrusion blow moulds. Extrusion plants for producing profiles comprise the elements: extruder, profile mould, calibrating unit, cooling zone, caterpillar take-off and roller take-off, separating device and tilting chute.

Blow moulding (see: http://de.wikipedia.org/wiki/Blasformen) is a method of producing hollow articles from thermoplastics and is counted among the special injection moulding methods. Blow moulding requires a so-called preform which is produced in an upstream operation by conventional injection moulding. The first step of the actual blow moulding process comprises heating this preform. This employs especially infrared lamps since they are not only suited for automation but also have a high output and introduce a lot of heat energy into the semifinished product. After heating, the preform is introduced into the mould, or alternatively—depending on the machine construction—the heaters are removed from the mould. The dosing of the mould results in a longitudinal stretching at the bottle neck, thereby holding the preform axially and also securing it in media-tight fashion. A gas is then introduced into the preform which expands under the applied pressure, thus reproducing the mould contours. For economic and environmental reasons the gas employed is often compressed air. After inflation, the hollow article produced cools down in the mould until it has sufficient rigidity to be ejected.

The articles of manufacture producible in accordance with the invention from the moulding materials may preferably be employed for applications where a high stability toward heat ageing is necessary, preferably in the motor vehicle, electrical, electronic, telecommunications, solar, information technology and computer industries, in the household, in sport, in medicine or in the leisure industry. Preference for such applications is given to the use of articles of manufacture in vehicles, particularly preferably motor vehicles, in particular in motor vehicle engine bays. The present invention therefore also relates to the use of thermoplastic moulding materials comprising the abovementioned compositions for the production of articles of manufacture having enhanced stability toward thermooxidative damage and/or photooxidative damage, preferably of articles of manufacture for motor vehicles, especially preferably of articles of manufacture for motor vehicle engine bays. The moulding materials according to the invention are also suitable for applications/mouldings or articles where, in addition to thermooxidative stability, stability toward photooxidative damage is also necessary, preferably solar installations.

In a preferred embodiment the articles of manufacture producible in accordance with the invention are heat-stabilized composites based on endless fibres, also known as organopanels, or else encapsulated or overmoulded composite structures, wherein the inventive heat stabilizer system is used either in the thermoplastic matrix of the composite structure or in the moulding material to be moulded or in both components. Heat-stabilized composites are disclosed in WO 2011/014754 A1 for example and overmoulded composite structures are described in WO 2011/014751 A1 for example.

### Method of Use

The invention further relates to the method of using the compositions according to the present invention in the form of fibres, films, mouldings, composite structures and overmoulded composite structures for the production of articles for the motor vehicle industry, electrical industry, electronic industry, telecommunications industry, information technology, solar and computer industries, for the household, for sport applications, for medical applications or for the leisure industry, particularly preferably for motor vehicles, very particularly preferably for motor vehicle engine bays.

The present invention further relates to the use of inventive compositions as moulding materials for producing articles of manufacture in the form of fibres, films, mouldings of any type, composite structures and overmoulded composite structures.

The present invention yet further relates to the use of a stabilizer system composed of iron oxalate and dipentaerythritol, preferably a stabilizer system composed of iron oxalate, dipentaerythritol and at least one copolymer of ethene and acrylic ester, in particular a stabilizer system composed of iron oxalate, dipentaerythritol and at least one copolymer of ethylene and 2-ethylhexyl acrylate for heat-stabilizing polyamides and articles made from those stabilized polyamides, preferably in the form of fibers, films, mouldings, composite structures and overmoulded composite structures.

The present invention yet further relates to a method of heat-stabilizing polyamides and articles of manufacture producible therefrom in the form of fibres, films or mouldings, by using a stabilizer system composed of iron oxalate and dipentaerythritol, preferably a stabilizer system composed of iron oxalate, dipentaerythritol, copper(I) iodide and potassium bromide or alternatively a stabilizer system composed of iron oxalate, dipentaerythritol and at least one copolymer of ethylene and an acrylic ester, preferably a stabilizer system composed of iron oxalate, dipentaerythritol and at least one copolymer of ethylene and 2-ethylhexyl acrylate.

The present application yet further relates to a method of reducing photooxidative damage and/or thermooxidative damage to polyamides and articles of manufacture producible therefrom in the form of films, fibres, mouldings, composite structures and overmoulded composite structures, by using as a stabilizer system iron oxalate and dipentaerythritol, preferably a stabilizer system composed of iron oxalate, dipentaerythritol and copper(I) iodide or alternatively a stabilizer system composed of iron oxalate, dipentaerythritol and at least one copolymer of ethylene and an acrylic ester, preferably a stabilizer system composed of iron oxalate, dipentaerythritol and at least one copolymer of ethylene and 2-ethylhexyl acrylate.

### EXAMPLES

The advantages of inventive compositions and moulding materials producible therefrom were demonstrated by initially producing a premixture of 10% iron oxalate and subsequently producing the polyamide moulding materials. All data reported in [%] are weight percentages.

### Production of a Premixture Comprising 10% Iron Oxalate

10 wt % of iron oxalate were mixed with 90 wt % of a polyamide PA 66 and 20 wt % of iron oxalate were mixed with 80 wt % of a polyamide PA6I in a ZSK 26 Compounder twin-screw extruder from Coperion Werner & Pfleiderer (Stuttgart, Germany) at a temperature of about 290° C., extruded into a water bath, cooled until pelletizable and pelletized. The pelletized material was dried for two days at 80° C. in a vacuum drying cabinet.

### Production of the Polyamide Moulding Materials

The individual components were mixed in a ZSK 26 Compounder twin-screw extruder from Coperion Werner & Pfleiderer (Stuttgart, Germany) at a temperature of about 290° C., extruded into a water bath, cooled until pelletizable and pelletized. The pelletized material was dried for two days at 70° C. in a vacuum drying cabinet

TABLE 1
Compositions of the moulding materials (all data in wt %).

| ingredient | ex. 1 | ex. 2 | ex. 3 |
|---|---|---|---|
| glass fibres | 30.000 | 30.000 | 35.000 |
| PA66 | 67.224 | 62.724 | 62.224 |
| monten ester wax | 0.142 | 0.142 | 0.142 |
| potassium bromide | 0.098 | 0.098 | 0.098 |
| copper(I) iodide | 0.036 | 0.036 | 0.036 |
| dipentaelythritol | 2.000 | 2.000 | 2.000 |
| iron(II) oxalate dihydrate | 0.500 | | 0.500 |
| premixture of 10% iron oxalate | | 5.000 | |
| dehydrate in PA66 | | | |

### Materials Used:

PA66: Polyamide 66, for example Vydyne® 50 BWFS from Ascend Performance Materials LLC Montan ester wax, for example Licowax® E from Clariant GmbH

Glass fibres, for example CS7928 from Lanxess Deutschland GmbH, Cologne

Potassium bromide, d₉₉<70 μm

Copper(I) iodide, d₉₉<70 μm

Iron(II) oxalate dihydrate [CAS No. 6047-25-2] with d₉₉<10 μm Dipentaerythritol (CAS No. 126-58-9 DiPenta93 from Perstorp Service GmbH Polyamide 6I, for example Durethan® T40 (T=transparent), unreinforced, from Lanxess Deutschland GmbH, Cologne

Microtalc, for example Talcron® MP 12-50 from Barrets Minerals Inc, Bethlehem, Pa., USA Elastomer modifier: ethylene-2-ethyhexylacrylate copolymer comprising 37% acrylate, for example LOTRYL® 37EH175 from Arkema Group

### Injection Moulding:

Injection moulding of the moulding materials obtained was carried out on a Demag ergotech100 injection moulding machine. The melt temperature was 290° C. and the mould temperature was 80° C. The test specimens were tensile specimens of 170 mm×10 mm×4 mm and flat test specimens of 80 mm×10 mm×4 mm.

### Ageing and Testing:

The tensile specimens were tested to breaking (ISO527) using a Zwick universal testing machine. The test speed was 5 mm/min. The flat test specimens were tested in an impact test to IZOD ISO180-1U. The test was carried out at 23° C.

To test ageing behaviour, test specimens were stored in a circulating air drying cabinet at 200° C. for 1000 h, 2000 h and 3000 h and then tested under the indicated test conditions.

| Ingredient | comp. ex. 1 | ex. 4 | ex. 5 |
|---|---|---|---|
| glass fibres | 35.000 | 35.000 | 35.000 |
| PA66 | 62.625 | 60.125 | 60.625 |
| montan ester wax | 0.142 | 0.142 | 0.142 |
| potassium bromide | 0.098 | 0.098 | 0.098 |
| copper(I) iodide | 0.036 | 0.036 | 0.036 |
| Dipentaerythritol | 2.000 | 2.000 | 3.000 |
| carbon black | 0.099 | 0.099 | 0.099 |
| iron oxalate dihydrate | | | 1.000 |
| premixture of 20% iron | | 2.500 | |
| oxalate dihydrate in PA6I | | | |
| freshly moulded | | | |
| impact strength | 61 | 57 | 56 |
| breaking stress (MPa) | 192 | 187 | 193 |
| breaking elongation (%) | 3.2 | 2.7 | 2.7 |
| elastic modulus (MPa) | 11411 | 11986 | 12140 |
| after 1008 h/220° C. | | | |
| impact strength (kJ/m²) | 35 | 25 | 20 |
| breaking stress (MPa) | 126 | 150 | 143 |
| breaking elongation (%) | 1.3 | 1.6 | 1.6 |
| elastic modulus (MPa) | 11579 | 11676 | 11491 |
| after 2016 h/220° C. | | | |
| impact strength (kJ/m²) | 7 | 19 | 4 |
| breaking stress (MPa) | 1 | 84 | 54 |
| breaking elongation (%) | 0.2 | 1.4 | 1.1 |
| elastic modulus (MPa) | 660 | 7755 | 6127 |

| | comp. | | | | | |
|---|---|---|---|---|---|---|
| Ingredient | ex. 2 | ex. 6 | ex. 7 | ex. 8 | ex. 9 | ex. 10 |
| glass fibres | 30.000 | 30.000 | 30.000 | 30.000 | 30.000 | 30.000 |
| PA66 | 65.708 | 63.208 | 60.708 | 58.208 | 55.708 | 54.708 |
| montan ester wax | 0.140 | 0.140 | 0.140 | 0.140 | 0.140 | 0.140 |
| potassium bromide | 0.098 | 0.098 | 0.098 | 0.098 | 0.098 | 0.098 |
| copper(I) iodide | 0.036 | 0.036 | 0.036 | 0.036 | 0.036 | 0.036 |
| dipentaerythritol | 2.000 | 2.000 | 2.000 | 2.000 | 2.000 | 3.000 |
| microtalc | 0.018 | 0.018 | 0.018 | 0.018 | 0.018 | 0.018 |
| elastomer modifier | 2.000 | 2.000 | 2.000 | 2.000 | 2.000 | 2.000 |
| premixture of 10% iron | | 2.500 | 5.000 | 7.500 | 10.000 | 10.000 |
| oxalate in PA6 | | | | | | |

freshly moulded

| | | | | | | |
|---|---|---|---|---|---|---|
| impact strength (kJ/m²) | 66 | 69 | 78 | 74 | 75 | 72 |
| breaking stress (MPa) | 177 | 173 | 174 | 173 | 172 | 168 |
| breaking elongation (%) | 3.5 | 3.4 | 3.4 | 3.4 | 3.4 | 3.4 |
| elastic modulus (MPa) | 10123 | 9810 | 9889 | 10021 | 9946 | 9949 |

after 1008 h/220° C.

| | | | | | | |
|---|---|---|---|---|---|---|
| impact strength (kJ/m²) | 27 | 33 | 37 | 34 | 38 | 39 |
| breaking stress (MPa) | 103 | 148 | 159 | 168 | 172 | 179 |
| breaking elongation (%) | 1.3 | 1.9 | 2 | 2.3 | 2.4 | 2.7 |
| elastic modulus (MPa) | 9926 | 10082 | 10545 | 10226 | 10324 | 10376 |

after 2016 h/220° C.

| | | | | | | |
|---|---|---|---|---|---|---|
| impact strength (kJ/m²) | 4 | 20 | 22 | 19 | 26 | 33 |
| breaking stress (MPa) | 28 | 109 | 107 | 103 | 138 | 165 |
| breaking elongation (%) | 0.6 | 1.6 | 1.7 | 1.5 | 1.8 | 2.2 |
| elastic modulus (MPa) | 5920 | 8729 | 8645 | 8632 | 9743 | 10353 |

after 3024 h/220° C.

| | | | | | | |
|---|---|---|---|---|---|---|
| impact strength (kJ/m²) | 1 | 9 | 6 | 7 | 10 | 44 |
| breaking stress (MPa) | | 28 | 58 | 145 | 152 | 173 |
| breaking elongation (%) | — | 0.8 | 0.9 | 1.9 | 2.1 | 2.7 |
| elastic modulus (MPa) | — | 4130 | 7281 | 10197 | 10062 | 10326 |

What is claimed is:

1. A composition comprising:
A) at least one polyamide or copolyamide;
B) iron oxalate;
C) dipentaerythritol; and
D) at least one filler or reinforcer.

2. The composition according to claim 1, wherein the iron oxalate has an average particle diameter below 10 μm, determined by light scattering as per ISO 13320 following dispersion in water as per ISO 14887.

3. The composition according to claim 1, further comprising at least one further heat stabilizer E).

4. The composition according to claim 3, wherein the heat stabilizer E) comprises at least one copper(I) halide.

5. The composition according to claim 4, wherein the at least one copper(I) halide is copper(I) iodide.

6. The composition according to claim 3, further comprising at least one alkali metal halide F).

7. The composition according to claim 6, wherein the at least one alkali metal halide is selected from alkali metal chlorides, alkali metal bromides and alkali metal iodides.

8. The composition according to claim 6, wherein the at least one alkali metal halide is selected from sodium halides and/or potassium halides.

9. The composition according to claim 6, wherein the at least one alkali metal halide is selected from sodium chloride, potassium bromide, and potassium iodide.

10. The composition according to claim 6, wherein the at least one alkali metal halide is potassium bromide.

11. The composition according to claim 1, further comprising at least one further additive G).

12. The composition according to claim 11, wherein the additive G) comprises at least one copolymer of ethylene and acrylic ester.

13. The composition according to claim 12, wherein the copolymer is obtained from ethylene and 2-ethylhexyl acrylate.

14. The composition according to claim 1, further comprising:
at least one further heat stabilizer E);
at least one alkali metal halide F); and
at least one further additive G).

15. The composition according to claim 14, wherein:
the iron oxalate is particulate iron(II) oxalate dihydrate and/or particulate iron(II) oxalate hexahydrate wherein the particles have a d₅₀ of about 1 to about 8 μm, and a d₉₀ value below about 20 μm;
the at least one further heat stabilizer E) comprises at least one copper(I) halide;
the at least one alkali metal halide F) is selected from alkali metal chlorides, alkali metal bromides and alkali metal iodides; and
the at least one further additive G) comprises at least one copolymer of ethylene and acrylic ester, and at least one substance from the group of heat stabilizers distinct from components B) and E), UV stabilizers, gamma ray stabilizers, hydrolysis stabilizers, antistats, emulsifiers, nucleating agents, plasticizers, processing aids, impact modifiers, lubricants, demoulding agents, dyes and pigments.

16. The composition according to claim 15, wherein:
the iron oxalate particles have a d₅₀ of about 2 to about 2.5 μm, and a d₉₀ value of about 5 to about 10 μm;
the at least one copper(I) halide is copper(I) iodide;
the at least one alkali metal halide F) is potassium bromide and/or potassium iodide; and
the demoulding agents comprise montan ester waxes of straight-chain, saturated carboxylic acids having chain lengths of 28 to 32 carbon atoms or mixtures of waxes.

17. The composition according to claim 1, wherein the composition comprises, per 100 parts by weight of component A):
0.05 to 6 parts by weight of component B),
0.1 to 12 parts by weight of component C), and
5 to 280 parts by weight of component D).

18. A method of producing thermoplastic moulding materials, the method comprising mixing the components A), B), C) and D) according to claim 17 and extruding the mixture as a moulding material.

19. A method of producing articles of manufacture, the method comprising at least one of injection moulding, extruding, and blow moulding the thermoplastic material of claim 18 to produce articles of manufacture in the form of fibres, films, mouldings, composite structures, and overmoulded composite structures.

20. A method for heat-stabilizing polyamide compositions comprising polyamide and filler, the method comprising mixing the polyamide composition with stabilizer comprising iron oxalate and dipentaerythritol.
